(19) United States
(12) Patent Application Publication
(10) Pub. No.: US 2014/0104117 A1
(43) Pub. Date: Apr. 17, 2014

(54) INFORMATION PROCESSING APPARATUS

(71) Applicant: CASIO COMPUTER CO., LTD., Tokyo (JP)

(72) Inventor: Kan Ukawa, Tokyo (JP)

(73) Assignee: CASIO COMPUTER CO., LTD., Tokyo (JP)

(21) Appl. No.: 14/037,494

(22) Filed: Sep. 26, 2013

(30) Foreign Application Priority Data
Oct. 16, 2012 (JP) 2012-228548

(51) Int. Cl. H01Q 1/22

(52) U.S. Cl. CPC H01Q 1/2208
USPC 343/702

(57) ABSTRACT

An information processing apparatus of the present invention includes a case having a loop-shaped antenna provided therein, in which the antenna is bent by a bending portion to continue in a loop shape with its one portion positioned on the front surface side of the case and the other portion positioned on the back surface side of the case.

### CROSS-REFERENCE TO RELATED APPLICATION

This application is based upon and claims the benefit of priority from the prior Japanese Patent Application No. 2012-228548, filed Oct. 16, 2012, the entire contents of which are incorporated herein by reference.

### BACKGROUND OF THE INVENTION

1. Field of the Invention

The present invention relates to an information processing apparatus which performs communication with a non-contact type read target medium.

2. Description of the Related Art

An information processing apparatus having a reader/writer function is known which performs wireless communication in a non-contact state with a non-contact type (Near Field Communication (NFC)) read target medium, such as an Integrated Circuit (IC) card or an IC tag, using a radio wave in a frequency band of 13.56 MHz, as disclosed in Japanese Patent Application Laid-Open (Kokai) Publication No. 2011-034465.

In this type of information processing apparatus, a display section for electro-optically displaying information is provided within the equipment case, and a loop-shaped antenna is provided on the front surface of the equipment case on the front surface side of the display section along the periphery of the display section. This information processing apparatus performs wireless communication in a non-contact state with a non-contact type read target medium, such as an IC card or an IC tag, by a magnetic field generated in the antenna, whereby data is sent and received.

However, since the loop-shaped antenna is provided along the periphery of the display section on the front surface of the equipment case, this information processing apparatus cannot perform wireless communication with the read target medium unless the non-contact type read target medium, such as an IC card or an IC tag, is brought closer to the front surface of the equipment case. Therefore, it is inconvenient for wireless communication with an IC tag serving as a read target medium attached to an article such as a commodity.

More specifically, In communication between the information processing apparatus and an IC card serving as a read target medium, all that is required is that the IC card is brought closer to the front surface of the equipment case, whereby the user can perform communication between the information processing apparatus and the IC card while viewing the display section. However, in communication between the information processing apparatus and an IC tag serving as a read target medium, the front surface of the equipment case needs to be brought closer to the IC tag, and therefore the user cannot see the display section and confirm whether communication is being performed between the information processing apparatus and the IC tag.

### SUMMARY OF THE INVENTION

An object of the present invention is to enable communication between a non-contact type read target medium and both the front surface and the back surface of a equipment case using one antenna.

In accordance with one aspect of the present invention, there is provided an information processing apparatus comprising: a case having a loop-shaped antenna provided therein, wherein the antenna is bent by a bending portion to continue in a loop shape with one portion being positioned on front surface side of the case and other portion being positioned on back surface side of the case.

According to the present invention, communication between a non-contact type read target medium and both the front surface and the back surface of an equipment case can be performed using one antenna.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a perspective view on the front surface side of an information processing apparatus according to a first embodiment of the present invention;

FIG. 2 is a perspective view on the back surface side of the information processing apparatus illustrated in FIG. 1;

FIG. 3 is a rear view illustrating the inside of the equipment case by removing the rear case in the information processing apparatus illustrated in FIG. 2;

FIG. 4 is an enlarged perspective view illustrating the main section in the information processing apparatus illustrated in FIG. 3;

FIG. 5 is an enlarged perspective view of the main section in the information processing apparatus illustrated in FIG. 1, in which a portion thereof has been removed;

FIG. 6 is an enlarged sectional view of the main section of the information processing apparatus taken along line A-A in FIG. 4;

FIG. 7 is an enlarged perspective view illustrating an antenna in the information processing apparatus illustrated in FIG. 4; and

FIG. 8A and FIG. 8B are diagrams illustrating an information processing apparatus according to a second embodiment of the present invention, of which FIG. 8A is an enlarged sectional view illustrating the main section, and FIG. 8B is an enlarged perspective view illustrating an antenna.

### DETAILED DESCRIPTION OF THE PREFERRED EMBODIMENTS

### First Embodiment

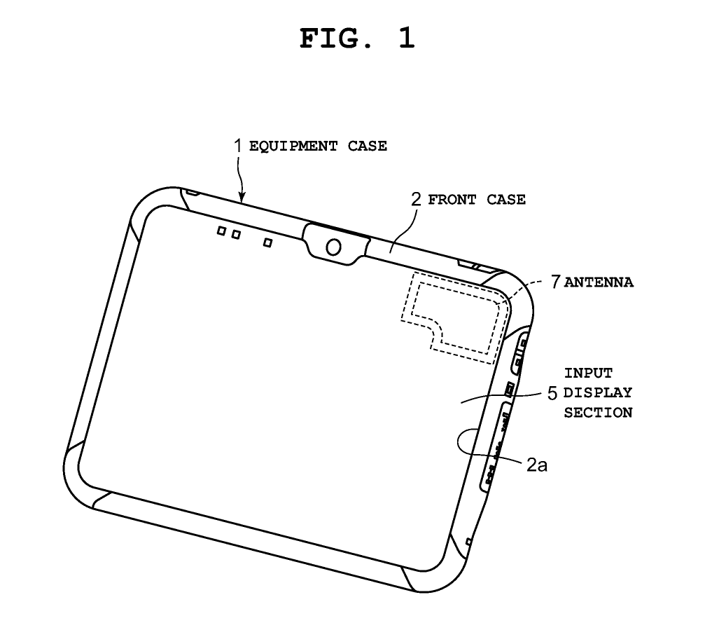

An information processing apparatus according to a first embodiment of the present invention will be described below with reference to FIG. 1 to FIG. 7.

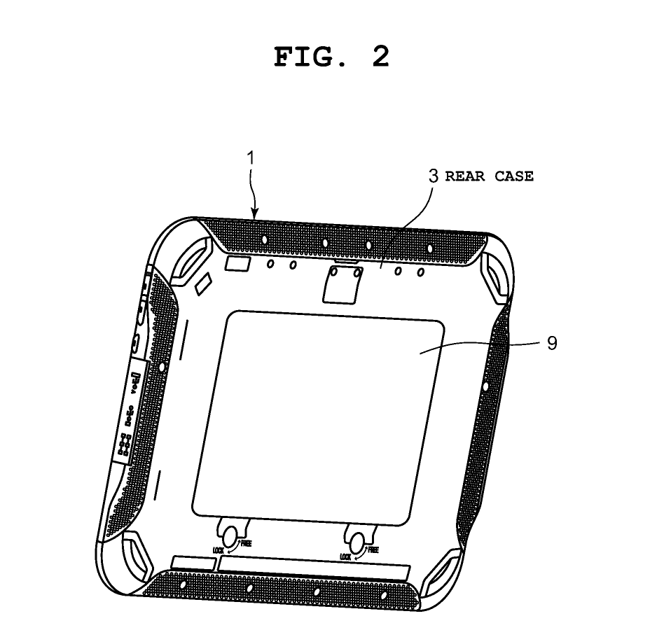

The information processing apparatus is a portable computer or a portable information terminal of a tablet type, and includes an equipment case 1, as illustrated in FIG. 1 and FIG. 2. The equipment case 1, which is formed in a substantially flat plate shape as a whole, includes a front case 2 and a rear case 3.

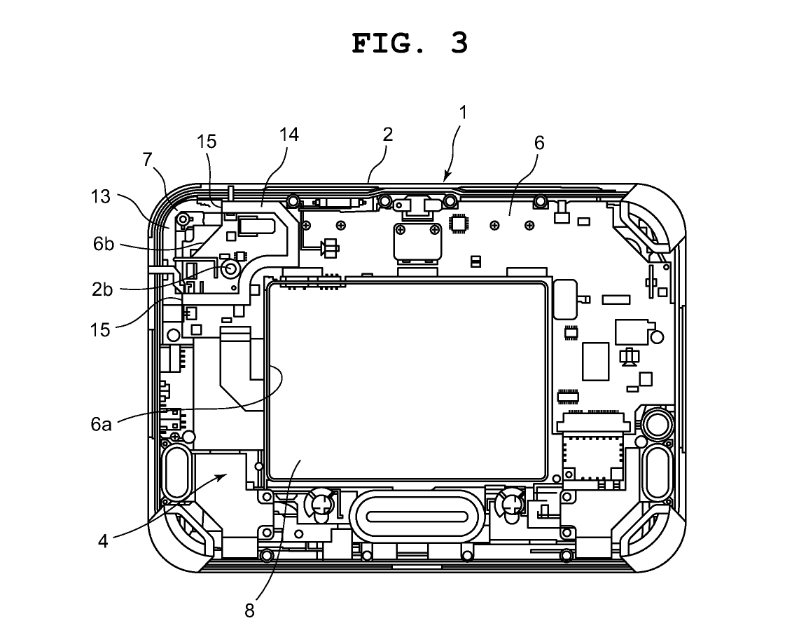

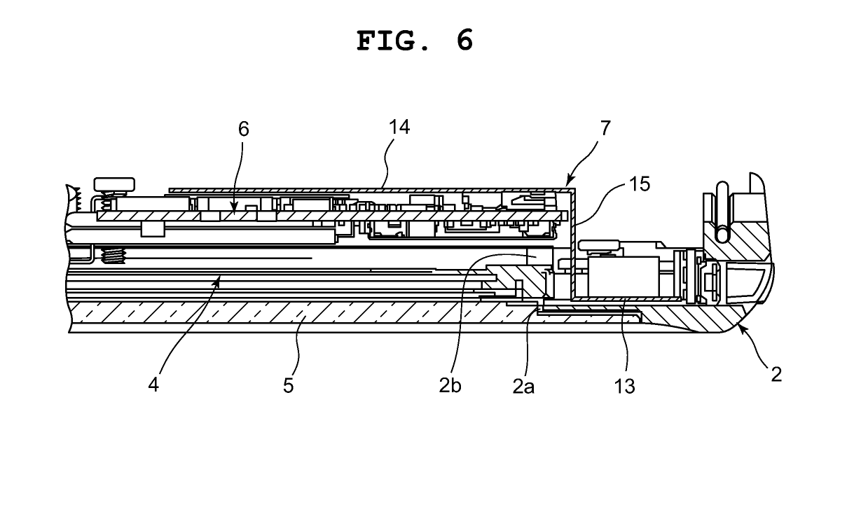

The equipment case 1 has an equipment module 4 arranged therein, as illustrated in FIG. 3 to FIG. 6. The equipment module 4 includes an input display section 5, a circuit board 6, an antenna 7, and a rechargeable battery 8. The input display section 5 is arranged within the front case 2 and exposed to the front surface (a lower surface in FIG. 6) of the front case 2 from an opening 2a provided on the front surface of the front case 2, as illustrated in FIG. 1 and FIG. 6. In this case, the input display section 5 is exposed to substantially the entire front surface excluding the peripheral edge of the front case 2.

This input display section 5 includes a display panel having a transparent touch panel arranged on its front surface and an input display board arranged on its back surface, as illustrated in FIG. 1 and FIG. 6. The display panel includes a flat display element such as a liquid crystal display element or an Electro-Luminescence (EL) display element, and electro-optically displays information.

Information is input to the display panel by a touch operation being performed on the surface of the touch panel, and the information displayed on the display panel is viewed through the touch panel. The input display board drives the display panel with the display panel and the touch panel being electrically connected to each other to display information while accepting information input by a touch operation on the touch panel.

The circuit board 6 is attached to a mounting boss 2b provided within the front case 2 and positioned on the back surface side of the input display section 5, as illustrated in FIG. 3 and FIG. 6. This circuit board 6 is formed in the shape of a flat plate having an opening 6a provided at its center. The input display section 5, the antenna 7, and the rechargeable battery 8 are electrically connected to the circuit board 6. In addition, various types of electronic components required for information processing are mounted on the circuit board 6.

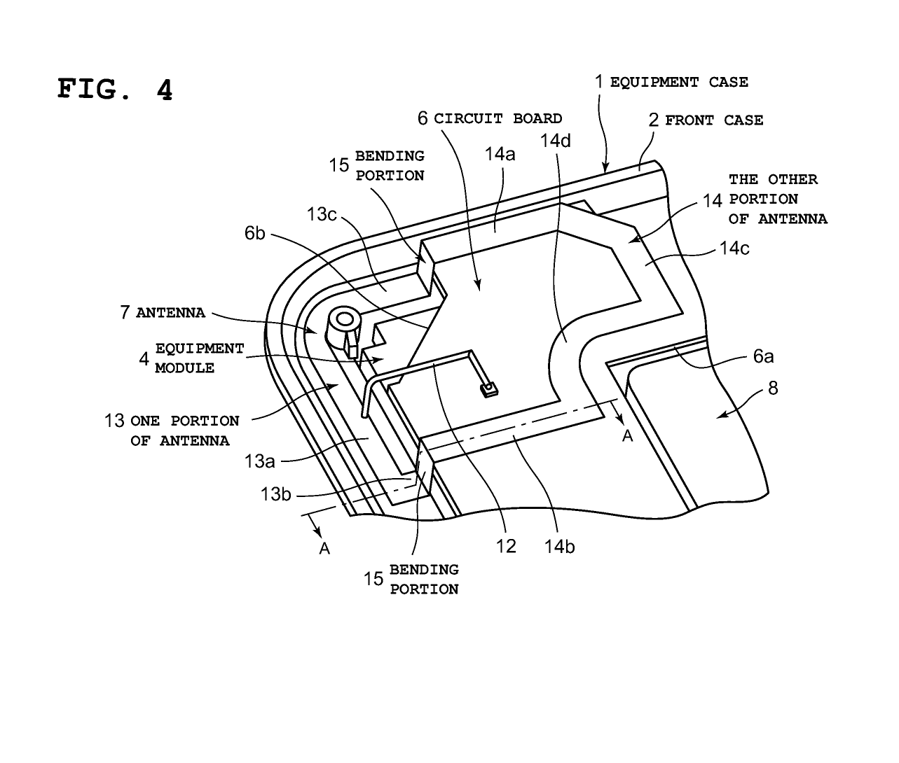

The rechargeable battery 8 is formed in a flat plate shape, and is arranged in the opening 6a of the circuit board 6, as illustrated in FIG. 3 and FIG. 4. In this case, a battery cover 9 is detachably attached to a portion of the rear case 3 corresponding to the rechargeable battery 8, as illustrated in FIG. 2. The rear case 3 is attached to the front case 2, and covers the circuit board 6 and the rechargeable battery 8. The rechargeable battery 8 includes a secondary battery such as a lithium polymer rechargeable battery.

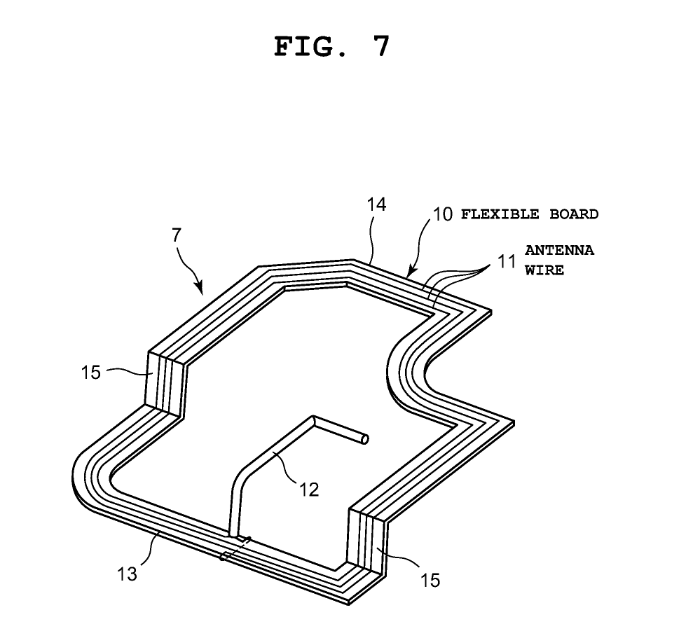

The antenna 7 is used to perform wireless communication using a radio wave in a frequency band of 13.56 MHz, and includes a flexible board 10 formed in a loop shape, and an antenna wire 11 continuously provided in a spiral shape on the flexible board 10, as illustrated in FIG. 4 and FIG. 7. The antenna wire 11 is electrically connected to the circuit board 6 via a connection cable 12. On the circuit board 6, a wireless communication circuit or a wireless communication module for causing the antenna 7 to perform wireless communication is mounted.

The antenna 7 is bent by a bending portion 15 to continue in a loop shape with its one portion 13 positioned within the equipment case 1 on the front surface side (the lower surface side in FIG. 4) thereof and the other portion 14 positioned within the equipment case 1 on the back surface side (the upper surface side in FIG. 4) thereof, as illustrated in FIG. 3 to FIG. 7.

More specifically, the one portion 13 of the antenna 7 is arranged on the inner surface of the front case 2, and the other portion 14 thereof is arranged on the back surface of the circuit board 6 serving as the back surface of the equipment module 4 positioned on the inner surface side of the rear case 3.

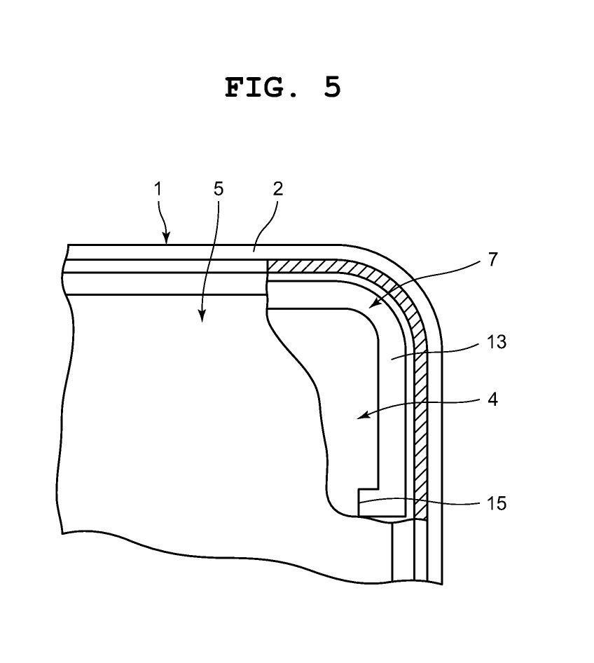

The antenna 7 is provided in a substantially rectangular shape at a corner of the equipment case 1, i.e., at the upper left corner of the front case 2 in FIG. 3, as illustrated in FIG. 3 and FIG. 4. In this case, a notch 6b is provided in a corner portion at the upper left of the circuit board 6, as illustrated in FIG. 4. Thus, the one portion 13 of the antenna 7 on the inner surface of the front case 2 is arranged on the inner surface of the front case 2 along the outer periphery of a corner portion at the upper left of the input display section 5, as illustrated in FIG. 4 and FIG. 5.

More specifically, the one portion 13 of the antenna 7 includes a left side portion 13a corresponding to the left side of the input display section 5, a lower side portion 13b extending from the lower end of the left side portion 13a toward a portion below the left side of the circuit board 6, and an upper side portion 13c extending from the upper end of the left side portion 13a toward a portion corresponding to the notch 6b in the circuit board 6 in FIG. 4. A substantially triangular area formed of the left side portion 13a, the lower side portion 13b, and the upper side portion 13c constitutes a communication area where a radio wave is generated.

On the other hand, the other portion 14 of the antenna 7 on the inner surface side of the rear case 3 is arranged on the back surface (the upper surface in FIG. 4) of the circuit board 6 serving as the back surface of the equipment module 4, as illustrated in FIG. 3 and FIG. 4. The other portion 14 of the antenna 7 includes an upper side portion 14a extending along and on the back surface of the circuit board 6 continuously from the upper side portion 13c of the one portion 13 of the antenna 7 via the bending portion 15, a lower side portion 14b extending along and on the back surface of the circuit board 6 continuously from the lower side portion 13b of the one portion 13 of the antenna 7 via the bending portion 15, and a right side portion 14c that is continuous with the right end of the upper side portion 14a and the right end of the lower side portion 14b.

In this case, the right end of the lower side portion 14b and the lower end of the right side portion 14c that is continuous therewith are connected to a curved portion 14d formed avoiding a corner portion of the rechargeable battery so as not to overlap with the corner portion of the rechargeable battery 8, as illustrated in FIG. 3 and FIG. 4. As a result, a substantially trapezoidal area formed of the upper side portion 14a, the lower side portion 14b, the right side portion 14c, and the curved portion 14d of the other portion 14 of the antenna 7 constitutes a communication area where a radio wave is generated.

Further, the bending portion 15 in the antenna 7 is provided by being bent almost vertically in the thickness direction of the equipment case 1, in an area located at an edge of the left side of the circuit board 6 and an edge of the notch 6b in the circuit board 6, as illustrated in FIG. 4, FIG. 6, and FIG. 7. The height of the bending portion 15 is substantially the same as the thickness of the equipment module 4 so that the one portion 13 and the other portion 14 are arranged with a step therebetween.

More specifically, by the flexible board 10 formed in a loop shape being bent by the bending portion 15 together with the antenna wire 11, the antenna 7 continues in a loop shape with the one portion 13 of the antenna 7 being arranged on the inner surface of the front case 2 and the other portion 14 of the antenna 7 being arranged on the back surface of the circuit board 6 in the equipment module 4, as illustrated in FIG. 3 to FIG. 7.

As a result, by the one portion 13 of the antenna 7 arranged on the inner surface of the front case 2 generating a radio wave, the antenna 7 can perform wireless communication in a non-contact state on the front surface side of the equipment case 1. In addition, by the other portion 14 of the antenna 7 arranged on the back surface of the circuit board 6 in the equipment module 4 and positioned on the side of the rear case 3 generating a radio wave, the antenna 7 can perform wireless communication in a non-contact state on the back surface side of the equipment case 1.

Next, the operation of the information processing apparatus is described.

When using the information processing apparatus, the user can input desired information by operating the touch panel while seeing information displayed on the display panel in the input display section 5.

In this state, when an IC card (not illustrated) serving as a non-contact type read target medium is brought closer to the front surface of the upper right corner of the equipment case 1 in FIG. 1, wireless communication is performed between the antenna 7 and the IC card by a magnetic field generated in the antenna 7, and thereby data is sent and received.

At this time, since the one portion 13 of the antenna 7 is on the inner surface of the front case 2, communication can be performed between the antenna 7 and the IC card which has approached the front surface of the equipment case 1 in a non-contact state, by the one portion 13 of the antenna 7 generating a radio wave required for communication, i.e., a radio wave in a frequency band of 13.56 MHz.

More specifically, by being arranged on the inner surface of the front case 2 and positioned within the equipment case 1 on the front surface side thereof along the outer periphery of the corner portion at the upper left of the input display section 5 in FIG. 4, the one portion 13 of the antenna 7 becomes a communication area while the user is viewing the input display section 5, and wireless communication can be performed in this communication area.

That is, the one portion 13 of the antenna 7 includes the left side portion 13a corresponding to the left side of the input display section 5, the lower side portion 13b extending from the lower end of the left side portion 13a toward the portion below the left side of the circuit board 6, and the upper side portion 13c extending from the upper end of the left side portion 13a toward the portion corresponding to the notch 6b in the circuit board 6 in FIG. 4. As a result, the substantially triangular area formed of the left side portion 13a, the lower side portion 13b, and the upper side portion 13c becomes the communication area, and communication can be performed in this communication area.

On the other hand, when the back surface at the upper right corner of the equipment case 1 in FIG. 1 is brought closer to an IC tag (not illustrated) serving as a non-contact type read target medium attached to an article such as a commodity, wireless communication is performed between the antenna 7 and the IC tag by a magnetic field generated in the antenna 7, and thereby data is sent and received.

At this time, since the other portion 14 of the antenna 7 is on the back surface of the circuit board 6 serving as the back surface of the equipment module 4 and is close to the rear case 3, wireless communication can be performed between the antenna 7 and the IC tag which has approached the back surface of the equipment case 1 in a non-contact state while the user is viewing the input display section 5, by the other portion 14 of the antenna 7 generating a radio wave required for communication.

That is, the other portion 14 of the antenna 7 includes the upper side portion 14a extending along and on the back surface of the circuit board 6 continuously from the upper side portion 13c of the one portion 13 of the antenna 7 via the bending portion 15, the lower side portion 14b extending along and on the back surface of the circuit board 6 continuously from the lower side portion 13b of the one portion 13 of the antenna 7 via the bending portion 15, the right side portion 14c that is continuous with the right end of the upper side portion 14a and the right end of the lower side portion 14b, and the curved portion 14d formed avoiding the corner portion of the rechargeable battery 8, as illustrated in FIG. 4. As a result, the substantially trapezoidal area formed of the upper side portion 14a, the lower side portion 14b, the right side portion 14c, and the curved portion 14d becomes the communication area, and communication can be performed in this communication area.

In this case, the other portion 14 of the antenna 7 can strongly generate a radio wave because the communication area therein has an area larger than that of the communication area in the one portion 13 of the antenna 7. Therefore, when the back surface at the corner of the equipment case 1 is brought closer to the IC tag, communication can be performed reliably and satisfactorily even if the distance therebetween is longer than that when the IC card is brought closer to the front surface at the corner of the equipment case 1.

Thus, in the information processing apparatus, the antenna 7 continues in a loop shape by being bent by the bending portion 15, with the one portion 13 of the antenna 7 in a loop shape provided within the equipment case 1 being positioned on the front surface side of the equipment case 1, and the other portion 14 of the antenna 7 being positioned on the back surface side of the equipment case 1. As a result, communication by the front surface and the back surface of the equipment case 1 can be performed by one antenna 7, which make the information processing apparatus convenient to use.

More specifically, in the information processing apparatus, with the use of the one portion 13 of the antenna 7 positioned within the equipment case 1 on the front surface side thereof, communication in a non-contact state can be performed by the front surface side of the equipment case 1. Also, with the use of the other portion 14 of the antenna 7 positioned within the equipment case 1 on the back surface side thereof, communication in a non-contact state can be performed by the back surface side of the equipment case 1. Thus, communication by the front surface and the back surface of the equipment case 1 can be performed by one antenna 7. Therefore, while the user is viewing the input display section 5, communication can be performed by the front surface and the back surface of the equipment case 1, which make the information processing apparatus convenient to use.

In the information processing apparatus, communication by the front surface and the back surface of the equipment case 1 is performed by one antenna 7. Accordingly, only one drive chip for one antenna 7 is required to be provided, by which the number of components can be reduced. This makes mounting work easy, and the entire information processing apparatus can be made light in weight and low in cost.

In this case, the antenna 7 includes the flexible board 10 formed in a loop shape, and the antenna wire 11 continuously provided in a spiral shape on the flexible board 10. Accordingly, the flexible board 10 can be freely bent together with the antenna wire 11. As a result, the flexible board 10 can be freely and satisfactorily bent by the bending portion 15, whereby the one portion 13 of the antenna 7 can be positioned on the front surface side of the equipment case 1, and the other portion 14 of the antenna 7 can be positioned on the back surface side of the equipment case 1, with the antenna 7 being continued in a loop shape.

Also, in this information processing apparatus, the equipment case 1 has the equipment module 4 provided therein which includes the input display section 5 exposed to the front surface of the equipment case 1, and the one portion 13 of the antenna 7 positioned within the equipment case 1 on the front surface side thereof is arranged on the outer periphery of the input display section 5. Accordingly, even though the equipment module 4 including the input display section 5 is provided within the equipment case 1, the one portion 13 of the antenna 7 positioned within the equipment case 1 on the front surface side thereof can perform communication reliably and satisfactorily by the front surface side of the equipment case 1 without being affected by the input display section 5.

In this case, the other portion 14 of the antenna 7 positioned within the equipment case 1 on the back surface side thereof is arranged on the back surface of the equipment module 4. Accordingly, even though the equipment module 4 including the input display section 5 is provided within the equipment case 1, the other portion 14 of the antenna 7 positioned within the equipment case 1 on the back surface side thereof can perform communication reliably and satisfactorily by the back surface side of the equipment case 1 without being affected by the equipment module 4.

Also, in the information processing apparatus, the antenna is provided at the corner of the equipment case 1. Accordingly, the one portion 13 of the antenna 7 positioned within the equipment case 1 on the front surface side thereof can be arranged within the equipment case 1 on the front surface side thereof along the outer periphery of the corner portion of the input display section 5. Thus, the area of the communication area in the one portion 13 of the antenna 7 can be ensured.

More specifically, the one portion 13 of the antenna 7 positioned within the equipment case 1 on the front surface side thereof is arranged on the inner surface of the front case 2 along the outer periphery of the corner portion at the upper left of the input display section 5 in FIG. 4. Thus, the area of the communication area in the one portion 13 of the antenna 7 can be ensured, and a radio wave required to communicate a read target medium can be generated, whereby communication can be performed reliably and satisfactorily.

In this case, the one portion 13 of the antenna 7 includes the left side portion 13a corresponding to the left side of the input display section 5, the lower side portion 13b extending from the lower end of the left side portion 13a toward the portion below the left side of the circuit board 6, and the upper side portion 13c extending from the upper end of the left side portion 13a toward the portion corresponding to the notch 6b in the circuit board 6, as shown in FIG. 4. Thus, the left side portion 13a, the lower side portion 13b, and the upper side portion 13c can form the substantially triangular communication area, which enables a communication area to be ensured.

Also, the other portion 14 of the antenna 7 positioned within the equipment case 1 on the back surface side thereof is arranged to be sufficiently large on the back surface of the circuit board 6 serving as the back surface of the equipment module 4. Accordingly, the area of the communication area in the other portion 14 of the antenna 7 can be ensured to be sufficiently larger than the area of the communication area in the one portion 13 of the antenna 7.

Therefore, in communication by the back surface side of the equipment case 1, the other portion 14 of the antenna 7 can more strongly generate a radio wave than when communication is performed by the front surface side of the equipment case 1. Thus, even if the distance of the antenna 7 from the read target medium such as an IC card or an IC tag is made longer, communication can be performed reliably and satisfactorily.

### Second Embodiment

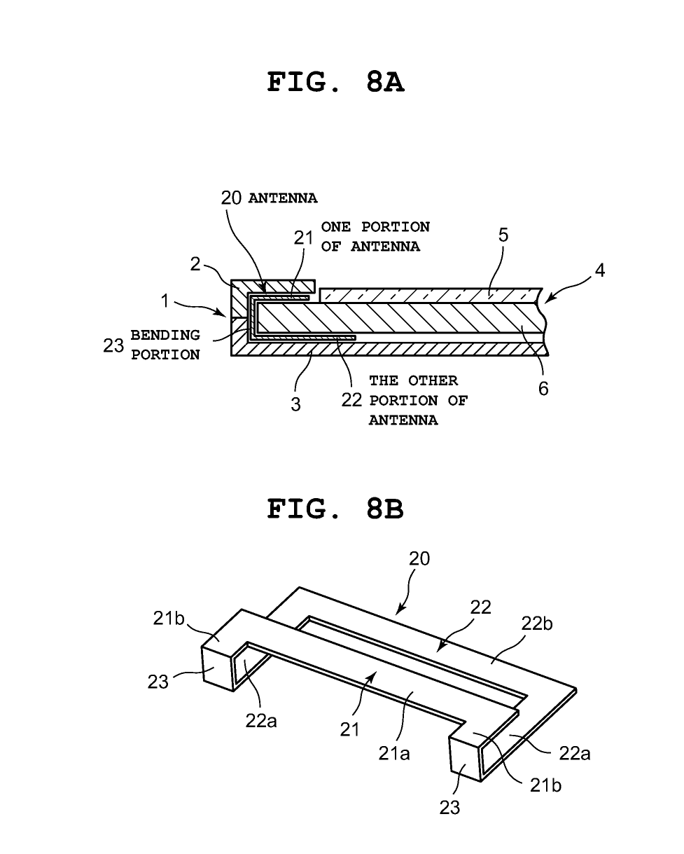

An information processing apparatus according to a second embodiment of the present invention will be described below with reference to FIGS. 8A and 8B.

Note that components identical to those of the first embodiment illustrated in FIG. 1 to FIG. 7 are given the same reference numerals for description.

The information processing apparatus has substantially the same structure as that of the first embodiment except for the structure of an antenna 20.

The antenna 20 is used to perform wireless communication using a radio wave in a frequency band of 13.56 MHz, and includes the flexible board 10 formed in a loop shape, and the antenna wire 11 continuously provided in a spiral shape on the flexible board 10, as with the first embodiment. The antenna wire 11 is electrically connected to the circuit board 6 via a connection cable (not illustrated).

The antenna 20 is bent by a bending portion 23 to continue in a loop shape with its one portion 21 positioned within the equipment case 1 on the front surface side (the upper surface side in FIG. 8A) thereof and the other portion 22 positioned within the equipment case 1 on the back surface side (the lower surface side in FIG. 8A) thereof, as illustrated in FIG. 8A to FIG. 8B. More specifically, the bending portion 23 in the antenna 20 is formed to have substantially the same height as the thickness of the equipment module 4 provided within the equipment case 1.

As a result, the equipment module 4 is held within the antenna 20 with the one portion 21 of the antenna 20 being arranged on the front surface side of the equipment module 4 and the other portion 22 of the antenna 20 being arranged on the back surface side of the equipment module 4, as illustrated in FIG. 8A and FIG. 8B. In this case, the one portion 21 of the antenna 20 is arranged on the outer periphery of the input display section 5 positioned on the front surface side of the equipment module 4. The other portion 22 of the antenna 20 is arranged on the back surface of the circuit board 6 positioned on the back surface of the equipment module 4.

More specifically, the one portion 21 of the antenna 20 includes a linear portion 21a formed in a substantially linear shape along the outer periphery of the input display section 5 positioned on the front surface side of the equipment module 4, and a pair of extension portions 21b respectively extending from side portions at both ends of the linear portion 21a toward the outside of the equipment case. A substantially rectangular area formed of the linear portion 21a and the pair of extension portion 21b forms a communication area where a radio wave is generated.

The bending portions 23 in the antenna 20 are respectively provided in an almost perpendicularly bent state at ends of the pair of extension portions 21b in the one portion 21 of the antenna 20, as illustrated in FIG. 8A and FIG. 8B. The other portion 22 of the antenna 20 includes a pair of extension portions 22a respectively extending from upper ends of the bending portions 23 toward the inside of the equipment case 1 along the back surface of the circuit board 6, and a connection portion 22b connected to respective ends of the pair of extension portions 22a. A substantially rectangular area formed of the pair of extension portions 22a and the connection portion 22b forms a communication area where a radio wave is generated.

In this case, the linear portion 21a in the one portion 21 of the antenna 20 and the connection portion 22b in the other portion 22 of the antenna 20 have substantially the same length, as illustrated in FIG. 8A and FIG. 8B. The pair of extension portions 22a in the other portion 22 of the antenna 20 has a length larger than the length of the pair of extension portions 21b in the one portion 21 of the antenna 20. Accordingly, the other portion 22 of the antenna 20 strongly generates a radio wave because the area of the communication area in the other portion 22 of the antenna 20 is made larger than the area of the communication area in the one portion 21 of the antenna 20.

Next, the operation of the information processing apparatus including this antenna 20 will be described below.

This information processing apparatus can be used in the same manner as that of the first embodiment. More specifically, when an IC card (not illustrated) serving as a non-contact type read target medium is brought closer to a portion of the front surface of the equipment case 1 in which the antenna 20 has been provided, wireless communication is performed between the antenna 20 and the IC card by a magnetic field generated in the antenna 20, whereby data is sent and received.

At this time, since the one portion 21 of the antenna 20 is within the equipment case 1 on the front surface side thereof, communication can be performed between the antenna 20 and the IC card which has approached the front surface of the equipment case 1 in a non-contact state by the one portion 21 of the antenna 20 generating a radio wave required for communication, i.e., a radio wave in a frequency band of 13.56 MHz. More specifically, by being arranged within the equipment case 1 on the front surface side thereof along the outer periphery of the input display section 5, the one portion 21 of the antenna 20 becomes a communication area while the user is viewing the input display section 5, and wireless communication can be performed in this communication area.

In this case, the one portion 21 of the antenna 20 includes the linear portion 21a formed in a substantially linear shape along the outer periphery of the input display section 5, and the pair of extension portions 21b respectively extending from the side portions at the ends of the linear portion 21a toward the outside of the equipment case 1, as illustrated in FIG. 8A and FIG. 8B. As a result, the substantially rectangular area formed of the linear portion 21a and the pair of extension portions 21b becomes a communication area, and communication can be performed in this communication area.

On the other hand, when a portion of the back surface of the equipment case 1 in which the antenna 20 has been provided is brought closer to an IC tag (not illustrated) serving as a non-contact type read target medium attached to an article such as a commodity, wireless communication is performed between the antenna 20 and the IC tag by a magnetic field generated in the antenna 20, whereby data is sent and received. At this time, since the other portion 22 of the antenna 20 is on the back surface of the circuit board 6 serving as the back surface of the equipment module 4, communication can be performed between the antenna 20 and the IC tag which has approached the back surface of the equipment case 1 in a non-contact state while the user is viewing the input display section 5, by the other portion 22 of the antenna 20 generating a radio wave required for communication.

That is, the other portion 22 of the antenna 20 includes the pair of extension portions 22a respectively extending along and on the back surface of the circuit board 6 continuously from respective sides at the ends of the linear portion 21a of the one portion 21 of the antenna 20 via the bending portions 23, and the connection portion 22b connected to the respective ends of the pair of extension portions 22a. As a result, the substantially rectangular area formed of the pair of extension portions 22a and the connection portion 22b becomes a communication area, and communication can be performed in this communication area.

In this case, the other portion 22 of the antenna 20 can strongly generate a radio wave because the communication area therein has an area larger than that of the communication area in the one portion 21 of the antenna 20. Accordingly, even if the distance between the back surface of the equipment case 1 and the IC tag serving as a read target medium when the back surface is brought closer to the IC tag is longer than that of when the IC card serving as a read target medium is brought closer to the front surface of the equipment case 1, communication can be performed reliably and satisfactorily.

As described above, in this information processing apparatus as well, the one portion 21 of the antenna 20 positioned within the equipment case 1 on the front surface side thereof can perform communication in a non-contact state on the front surface side of the equipment case 1, and the other portion 22 of the antenna 20 positioned within the equipment case 1 on the back surface side thereof can also perform communication in a non-contact state on the back surface side of the equipment case 1. As a result, communication by the front surface and the back surface of the equipment case 1 can be performed by one antenna 20. Accordingly, as with the first embodiment, the user can perform communication by the front surface and the back surface of the equipment case 1 while viewing the input display section 5, which makes the information processing apparatus convenient to use.

In this case as well, the equipment case 1 has the equipment module 4 provided therein which includes the input display section 5 exposed to the front surface of the equipment case 1 as in the case of the first embodiment, and the one portion 21 of the antenna 20 positioned within the equipment case 1 on the front surface side thereof is arranged on the outer periphery of the input display section 5. Accordingly, even though the equipment module 4 including the input display section 5 is provided within the equipment case 1, the one portion 21 of the antenna 20 positioned within the equipment case 1 on the front surface side thereof can perform communication reliably and satisfactorily by the front surface side of the equipment case 1 without being affected by the input display section 5.

More specifically, the one portion 21 of the antenna 20 positioned within the equipment case 1 on the front surface side thereof includes the linear portion 21a formed in a substantially linear shape along the outer periphery of the input display section 5 positioned on the front surface side of the equipment module 4, and the pair of extension portions 21b respectively extending from the side portions at the ends of the linear portion 21a toward the outside of the equipment case, and the substantially rectangular area can be formed by the linear portion 21a and the pair of extension portions 21b. This communication area enables a communication area to be ensured.

Also, the other portion 22 of the antenna 20 within the equipment case 1 on the back surface side thereof is arranged on the back surface of the equipment module 4. Accordingly, even though the equipment module 4 including the input display section 5 is provided within the equipment case 1, the other portion 22 of the antenna 20 positioned within the equipment case 1 on the back surface side thereof can perform communication reliably and satisfactorily by the back surface side of the equipment case 1 without being affected by the equipment module 4.

More specifically, the other portion 22 of the antenna 20 includes the pair of extension portions 22a respectively extending from the upper ends of the bending portions 23 in the antenna 20 toward the inside of the equipment case 1 along the back surface of the circuit board 6, and the connection portion 22b connected to the respective ends of the pair of extension portions 22a, and the substantially rectangular communication area can be formed by the pair of extension portions 22a and the connection portion 22b. This communication area enables a communication area to be ensured.

In this case, the area of the communication area in the other portion 22 of the antenna 20 is made larger than the area of the communication area in the one portion 21 of the antenna 20. Therefore, in communication by the back surface side of the equipment case 1, the other portion 22 of the antenna 20 can more strongly generate a radio wave than when communication is performed by the front surface side of the equipment case 1. Thus, even if the distance of the antenna 20 from the read target medium such as an IC card or an IC tag is made longer, communication can be performed reliably and satisfactorily.

In each of the above-mentioned first and second embodiments, the equipment module 4 provided within the equipment case 1 includes the input display section 5. However, the equipment module 4 need not necessarily include the input display section 5, and a structure may be adopted in which an input section and a display section are provided in parallel on the same plane.

Also, in the above-mentioned first and second embodiments, the antennas 7 and 20 are provided at the corners of the equipment cases 1, respectively. However, the antennas 7 and 20 need not necessarily be provided at the corners of the equipment cases 1, and may be respectively provided in the side portions of the equipment cases 1.

Moreover, in the above-mentioned first and second embodiments, the information processing apparatus of a tablet type has been described. However, the information processing apparatus need not necessarily be of a tablet type, and the present invention can be widely applied to various information processing apparatuses having a read/write function.

Furthermore, in the above-mentioned first and second embodiments, the antennas 7 and 20 are structured by the flexible board 10. However, the antennas 7 and 20 need not necessarily be structured by a flexible board, and may be structured by a hard board.

While the present invention has been described with reference to the preferred embodiments, it is intended that the invention be not limited by any of the details of the description therein but includes all the embodiments which fall within the scope of the appended claims.

What is claimed is:

1. An information processing apparatus comprising:
a case having a loop-shaped antenna provided therein,
wherein the antenna is bent by a bending portion to continue in a loop shape with one portion being positioned on front surface side of the case and other portion being positioned on back surface side of the case.

2. The information processing apparatus according to claim 1, wherein the antenna is an antenna for performing wireless communication with a non-contact type read target medium.

3. The information processing apparatus according to claim 1, wherein the antenna includes a flexible board formed in a loop shape, and an antenna wire continuously provided in a spiral shape on the flexible board.

4. The information processing apparatus according to claim 1, wherein the case has a module provided therein which includes a display section exposed to front surface of the case, and the one portion of the antenna on the front surface side of the case is arranged on outer periphery of the display section.

5. The information processing apparatus according to claim 4, wherein the other portion of the antenna on the back surface side of the case is arranged on back surface of the module.

6. The information processing apparatus according to claim 1, wherein the antenna is provided at a corner of the case.
